(19) United States
(12) Patent Application Publication
(10) Pub. No.: US 2008/0078058 A1
(43) Pub. Date: Apr. 3, 2008

(54) HINGE ASSEMBLY AND FOLDABLE ELECTRONIC DEVICE USING THE SAME

(75) Inventors: SHENG-CHENG HSU, Tu-Cheng (TW); PU LUO, Shenzhen (CN); FAN-MING MENG, Shenzhen (CN); JIN-BU CAI, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/623,295

(22) Filed: Jan. 15, 2007

(30) Foreign Application Priority Data
Sep. 8, 2006 (CN) 200610062511.1

(51) Int. Cl. E05D 11/08

(52) U.S. Cl. 16/337

(57) ABSTRACT

An exemplary hinge assembly (100) includes a first body (10), a follower (30), a second body (60), and an elastic element (50). The first body includes a shaft portion (13) and a friction portion (20) located around the shaft portion. The friction portion is non-rotatable relative to the shaft portion. The friction portion includes a curved friction surface (23). The follower includes a curved follower surface (311) and a locking portion (33). The follower is located around the shaft portion and is rotatable relative to the shaft portion. The second body includes a locking portion (616). The locking portion of the follower is engaged in the locking portion of the second body to prevent the follower from rotating relative to the second body. The elastic element is located between the follower and the second body, so as to bias the follower surface against the friction surface.

### BACKGROUND OF THE INVENTION

1. Field of the Invention

The present invention generally relates to hinge assemblies, and particularly to a hinge assembly for a foldable electronic device. The present invention further relates to a foldable electronic device using the hinge assembly.

2. Discussion of the Related Art

With the development of wireless communication and information processing technology, foldable electronic devices such as notebook computers, mobile telephones and personal digital assistants (PDAs) have become popular. Various types of hinge assemblies are used to join a body and a cover of a foldable electronic device, so that the cover can open away from and close onto the body.

Generally, in a notebook computer, an angle of an opened cover relative to a body is adjusted via a hinge assembly of the notebook computer. The hinge assembly utilizes frictional force generated between two rotatable members to position the cover. However, a contacting area between the rotatable members is small, and the rotatable members abrade each other at the contacting area. Thus after extended use of the notebook computer, the cover is liable to become somewhat loose. When this happens, and the cover is opened up from the body, the cover is not steadily held in position relative to the body. This makes the notebook computer inconvenient and unsafe to use.

Therefore, a new hinge assembly is desired in order to overcome the above-described shortcomings.

### SUMMARY

A hinge assembly includes a first body, a follower, a second body, and an elastic element. The first body includes a shaft portion and a friction portion located around the shaft portion. The friction portion is non-rotatable relative to the shaft portion. The friction portion includes a curved friction surface. The follower includes a curved follower surface and a locking portion. The follower is located around the shaft portion of the first body and is rotatable relative to the shaft portion. The second body includes a locking portion. The locking portion of the follower is engaged in the locking portion of the second body to prevent the follower from rotating relative to the second body. The elastic element is located between the follower and the second body, wherein a distal end of the shaft portion is fixed to the second body, so that the elastic element is compressed and biases the follower surface of the follower against the friction surface of the friction portion.

Other novel features and advantages will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present hinge assembly and foldable electronic device. Moreover, in the drawings, like reference numerals designate corresponding parts throughout the several views.

FIG. 1 is an isometric view of a notebook computer incorporating a pair of hinge assemblies, each hinge assembly being in accordance with an exemplary embodiment of the present invention.

FIG. 2 is an enlarged view of a left-side one of the hinge assemblies of FIG. 1.

FIG. 3 is an exploded view of the hinge assembly of FIG. 2.

FIG. 4 is similar to FIG. 3, but viewed from another aspect.

FIG. 5 is a cross-sectional view of the hinge assembly of FIG. 2.

### DETAILED DESCRIPTION OF THE EMBODIMENTS

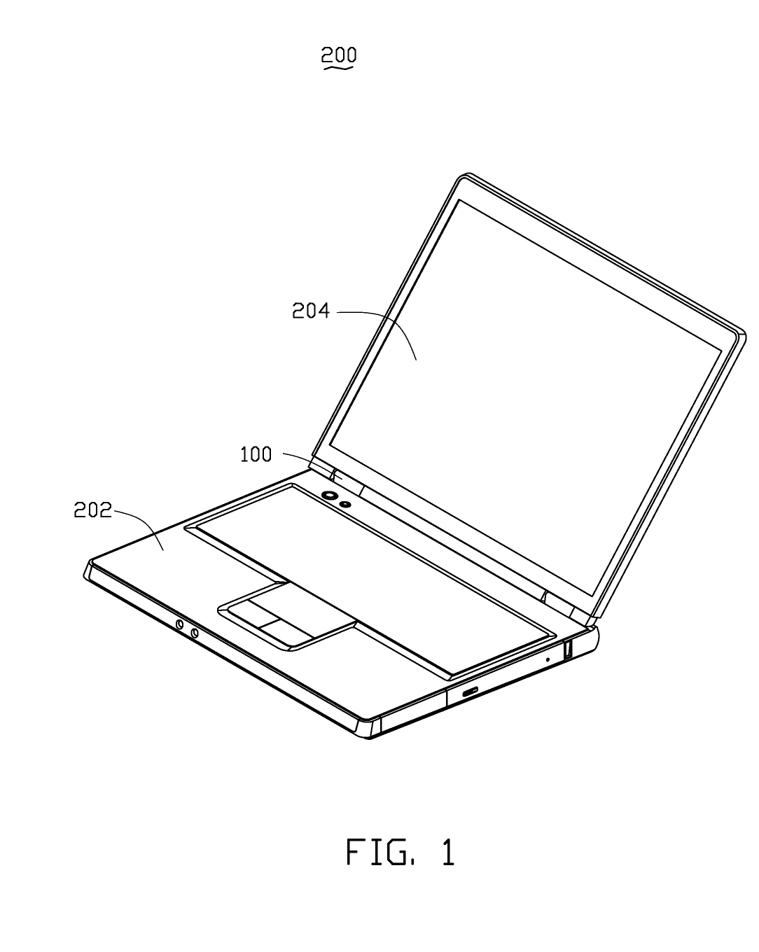

Referring to the drawings in detail, FIG. 1 shows a pair of hinge assemblies 100 incorporated in a foldable electronic device 200. The foldable electronic device 200 illustrated is a notebook computer 200. The notebook computer 200 is taken here as an exemplary application for the purposes of describing details of the hinge assembly 100 of the preferred embodiment. In alternative embodiments, the notebook computer 200 can be another kind of foldable electronic device, such as a personal digital assistant (PDA), an electronic dictionary, etc. The notebook computer 200 includes a main body 202 and a cover 204. The main body 202 and the cover 204 are pivotably connected to each other via the pair of hinge assemblies 100. In an alternative embodiment, the notebook computer 200 can include only one hinge assembly 100. For convenience, only one hinge assembly 100 is described hereinbelow.

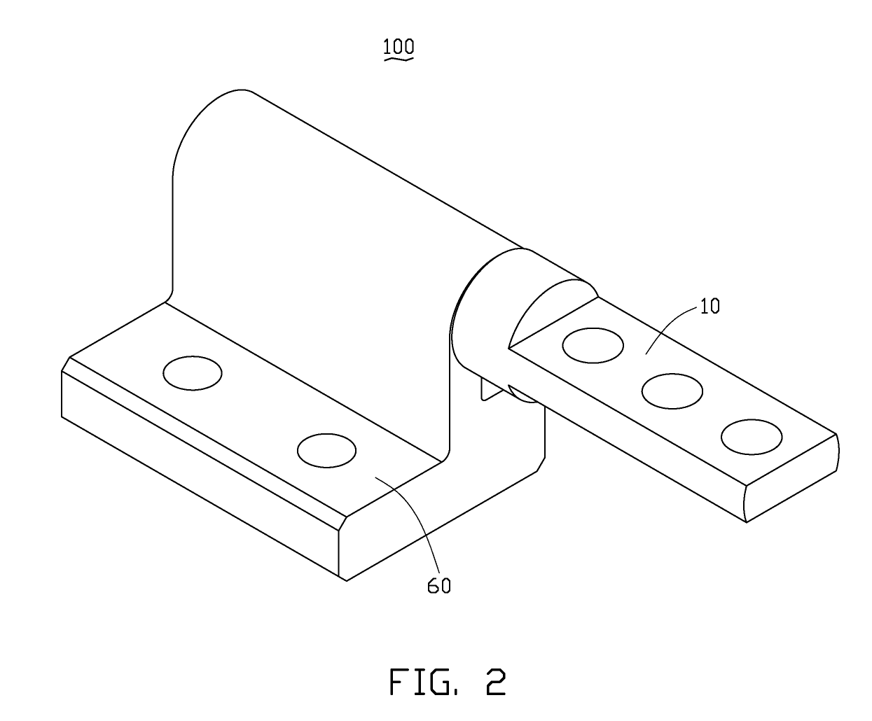

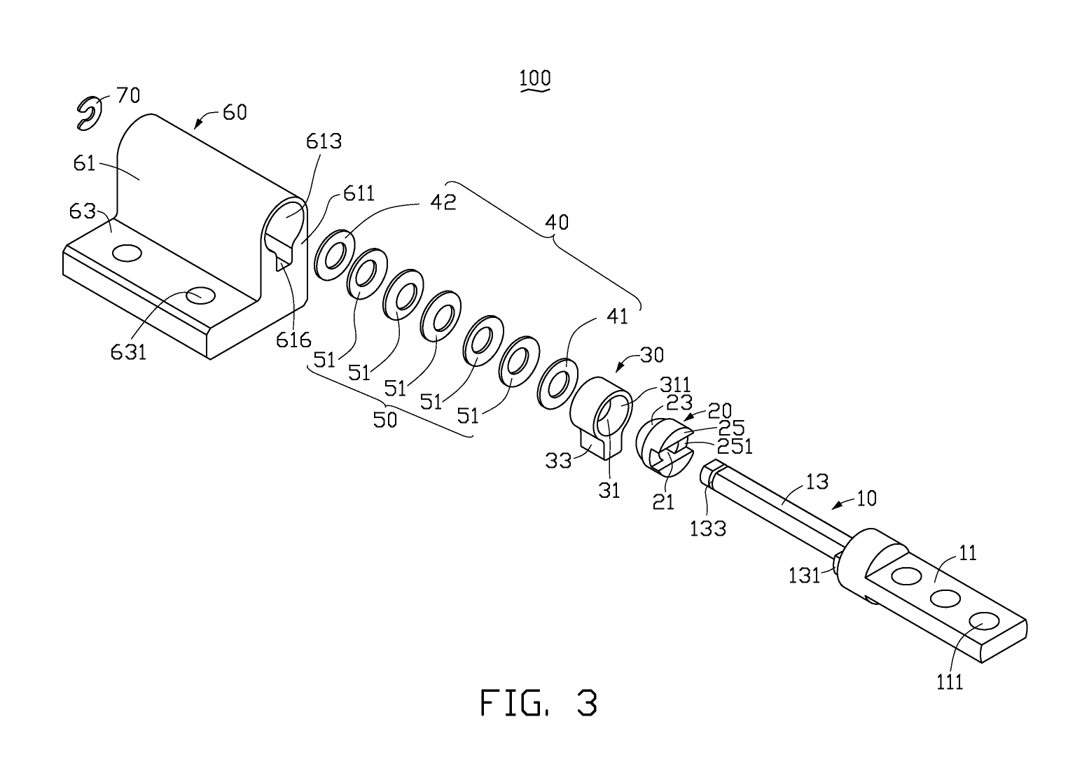

Referring to FIGS. 2 and 3, the hinge assembly 100 includes a first body 10, a second body 60, a friction member 20, a follower 30, a combination of washers 40, an elastic piece group 50, and a clip 70.

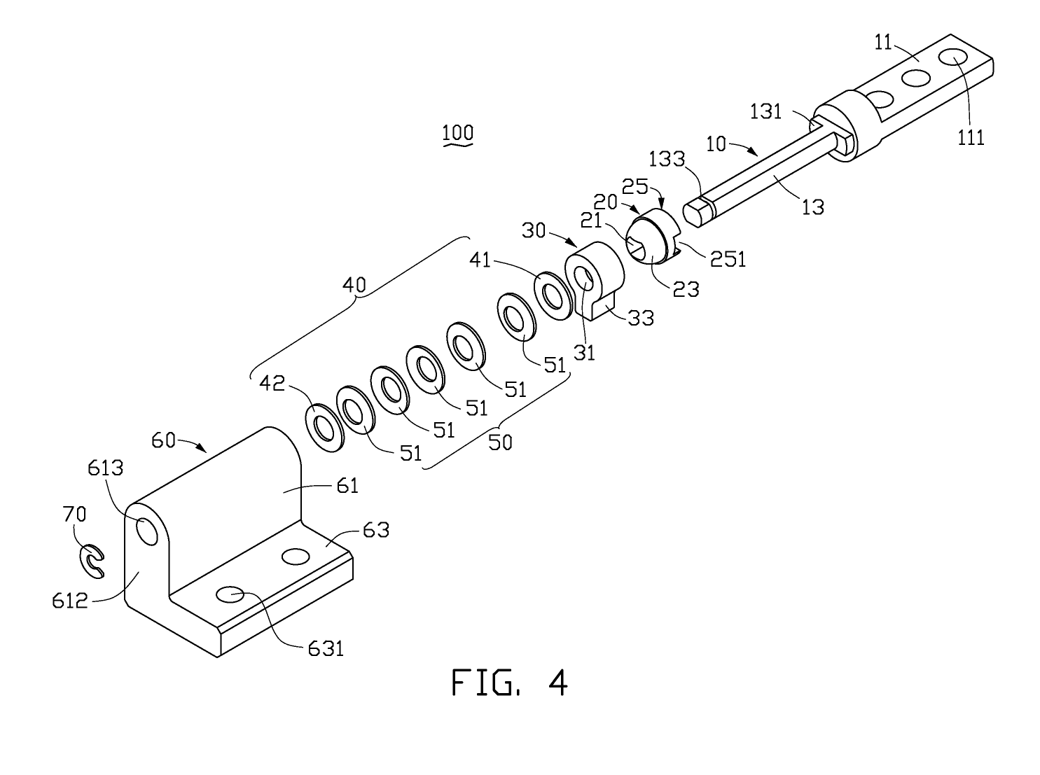

Referring also to FIG. 4, the first body 10 includes a first mounting plate 11, a connecting portion (not labeled) extending from one end of the first mounting plate 11, and a shaft portion 13 extending from one end of the connecting portion. The first mounting plate 11 defines at least one mounting hole 111. In the illustrated embodiment, the first mounting plate 11 defines three mounting holes 111. The mounting holes 111 are configured for engaging the first mounting plate 11 with the cover 204 of the notebook computer 200, so as to fix the first body 10 to the cover 204. The shaft portion 13 is substantially a cylindrical body. The shaft portion 13 includes a pair of opposite projections 131 extending perpendicularly from a first end thereof that adjoins the connecting portion. The shaft portion 13 defines a peripheral clip groove 133 in a second end thereof.

The friction member 20 defines a centre hole 21 running through a middle portion thereof. The friction member 20 is located around the shaft portion 13 of the first body 10, and abuts against the connecting portion. The friction member 20 is non-rotatable relative to the shaft portion 13. In an alternative embodiment, the friction member 20 may be integrally formed with the shaft portion 13 at the connecting portion. The friction member 20 includes a friction surface 23 formed at one end thereof, and a plane 25 formed at an opposite end thereof. The friction surface 23 is substantially a spherical surface. The friction member 20 further defines a transverse notch 251 at the plane 25. The projections 131 of the first body 10 are engaged in the notch 251 of the friction member 20, to prevent the friction member 20 from rotating relative to the first body 10.

The follower 30 is substantially a hollow cylindrical body, and defines a central hole 31 running through a middle portion thereof. The follower 30 is located around the shaft portion 13, and is rotatable relative to the shaft portion 13. The follower 30 has a follower surface 311 formed inside. The follower surface 311 is substantially a spherical surface, spans about half an axial length of the follower 30, and is exposed at an end of the follower 30 adjacent the friction member 20. A shape and a size of the follower surface 311 correspond to those of the friction surface 23 of the friction member 20. The follower surface 311 is configured for slidably engaging with the friction surface 23. In alternative embodiments, the follower surface 311 and the friction surface 23 may have other suitable complementary shapes, whereby the follower 30 is rotatable relative to the friction member 20. For example, the follower surface 311 and the friction surface 23 can be paraboloid surfaces or conical surfaces. The follower 30 includes a locking portion 33 extending from an outer wall thereof. The locking portion 33 is substantially a block-shaped protrusion having a rectangular profile.

The combination of washers 40 includes at least two washers, which are located around the shaft portion 13. In the illustrated embodiment, the combination of washers 40 includes a first washer 41 and a second washer 42. The first washer 41 is located between the follower 30 and the elastic piece group 50. The second washer 42 is located between the elastic piece group 50 and the second body 60. In an alternative embodiment, the combination of washers 40 can be omitted. In such case, the elastic piece group 50 directly abuts against the follower 30 and the second body 60.

The elastic piece group 50 includes at least two elastic pieces 51. In the illustrated embodiment, the elastic piece group 50 includes five elastic pieces 51. Each elastic piece 51 is made of an elastic material such as metal or plastic. In alternative embodiments, the elastic piece group 50 may instead be another kind of suitable elastic element, such as a compression spring. The elastic piece group 50 is located around the shaft portion 13, and functions to urge/push the follower surface 311 of the follower 30 to constantly abut against the friction surface 23 of the friction member 20.

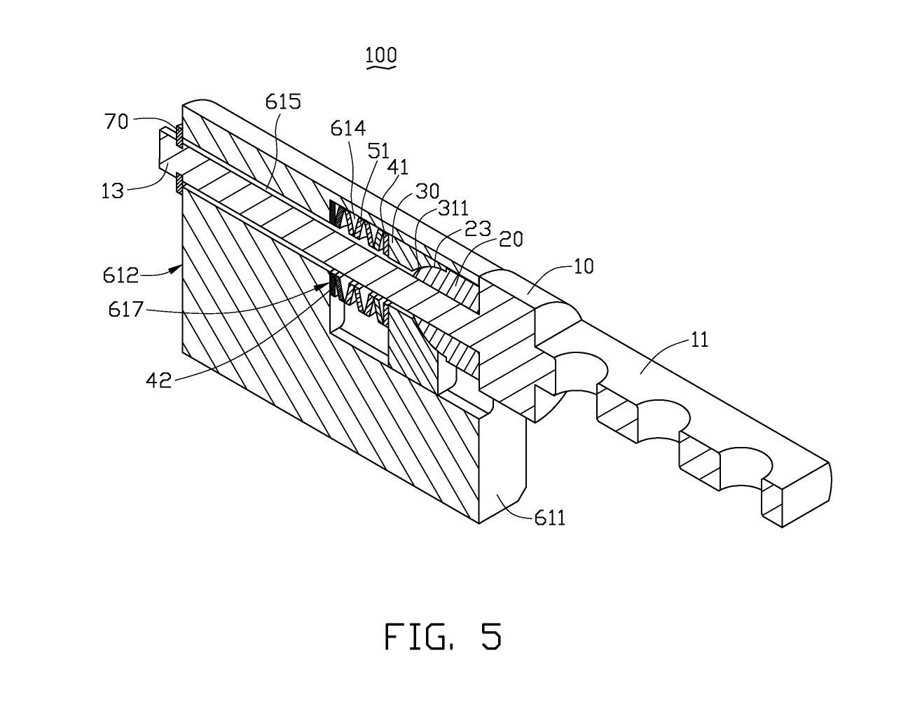

Referring also to FIG. 5, the second body 60 includes a knuckle 61, and a second mounting plate 63 extending from one side of the knuckle 61. The knuckle 61 has a first end surface 611, and a second end surface 612 opposite to the first end surface 611. The knuckle 61 defines a stepped cavity 613 running therethrough. The cavity 613 is configured for housing the shaft portion 13 of the first body 10, the friction member 20, the follower 30, the combination of washers 40, and the elastic piece group 50. The cavity 613 has a large diameter hole 614 and a small diameter hole 615. A locking portion 616 is formed in an inner wall of the knuckle 61 that bounds the large diameter hole 614. The locking portion 616 is substantially an elongate groove that defines a rectangular cross-section. The locking portion 33 of the follower 30 is engaged in the locking portion 616 of the second body 60, to prevent the follower 30 from rotating relative to the second body 60. A diameter of the small diameter hole 615 is less than that of the large diameter hole 614. A resisting surface 617 is formed inside the knuckle 61 where the small diameter hole 615 communicates with the large diameter hole 614. The second mounting plate 63 is substantially a rectangular body. In alternative embodiments, the second mounting plate 63 may have any of various other suitable shapes. For example, the second mounting plate 63 can be a polygonal body. The second mounting plate 63 defines at least one mounting hole 631. In the illustrated embodiment, the second mounting plate 63 defines two mounting holes 631. The mounting holes 631 are configured for engaging the second mounting plate 63 with the main body 202 of the notebook computer 200, so as to fix the second body 60 to the main body 202.

The clip 70 is substantially a C-shaped gapped ring, and is made of an elastic material such as metal or plastic. The clip 70 is engagably received in the clip groove 133 of the first body 10, to prevent the first body 10 from disengaging from the second body 60. In alternative embodiments, the clip 70 may be another kind of suitable fastener, for example a screw or a pin. If a screw is employed, a plurality of threads is defined on the shaft portion 13, and the screw is engaged with the threads to prevent the first body 10 from disengaging from the second body 60.

In assembly of the hinge assembly 100, the shaft portion 13 of the first body 10 is passed through the friction member 20, the follower 30, the first washer 41, the elastic piece group 50, the second washer 42, and the second body 60 in that order. The clip 70 is engaged in the clip groove 133 of the first body 10. The connecting portion of the first body 10 abuts against the first end surface 611 of the second body 60 and the plane 25 of the friction member 20. The projections 131 of the first body 10 are engaged in the notch 251 of the friction member 20. The locking portion 33 of the follower 30 is engaged in the locking portion 616 of the second body 60. The follower surface 311 of the follower 30 abuts against the friction surface 23 of the friction member 20, and an end of the follower 30 distal from the follower surface 311 abuts against a first end surface of the first washer 41. The five elastic pieces 51 are located around the shaft portion 13 to form the elastic piece group 50, with one elastic piece 51 abutting against another one or two corresponding elastic pieces 51. The elastic piece group 50 is elastically compressed, with one end of the elastic piece group 50 biasing a second end surface of the first washer 41, and an opposite end of the elastic piece group 50 biasing a first end surface of the second washer 42. A second end surface of the second washer 42 abuts against the resisting surface 617 of the second body 60. The hinge assembly 100 is thus completely assembled.

In use of the hinge assembly 100, the first mounting plate 11 of the first body 10 is engaged with the cover 204, and the second mounting plate 63 of the second body 60 is engaged with the main body 202. The biasing force provided by the elastic piece group 50 is constant. The cover 204 is opened from or closed upon the main body 202 by external force applied by a user. When the external force is withdrawn, the cover 204 rests at a steady position relative to the main body 202 by reason of frictional engagement between the friction surface 23 of the friction member 20 and the follower surface 311 of the follower 30.

In the notebook computer 200, the hinge assembly 100 controls an angle of opening of the cover 204 relative to the main body 202 by reason of the frictional engagement between the friction member 20 and the follower 30. This frictional engagement is in turn controlled by the elastic biasing force provided by the elastic piece group 50. A contact area between the friction surface 23 of the friction member 20 and the follower surface 311 of the follower 30 is large relative to the overall sizes of each of the friction member 20 and the follower 30. This means the friction member 20 and the follower 30 need not be unduly large. Because the contact area between the friction surface 23 of the friction member 20 and the follower surface 311 of the follower 30 is relatively large, the biasing force provided by the elastic piece group 50 need not be excessively great. This means the elastic piece group 50 need not be unduly large, and the elastic piece group 50 is less prone to fatigue. Furthermore, because the friction member 20, the follower 30, and means the elastic piece group 50 need not be unduly large, the hinge assembly 100 correspondingly need not be unduly large. Nevertheless, the hinge assembly 100 can still provide convenient and reliable positioning of the cover 204 relative to the main body 202.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A hinge assembly, comprising:
a first body comprising a shaft portion and a friction portion located around the shaft portion, the friction portion being non-rotatable relative to the shaft portion and comprising a curved friction surface;
a follower comprising a curved follower surface and a locking portion, the follower being located around the shaft portion of the first body and being rotatable relative to the shaft portion;
a second body comprising a locking portion, the locking portion of the follower being engaged in the locking portion of the second body to prevent the follower from rotating relative to the second body; and
an elastic element located between the follower and the second body;
wherein a distal end of the shaft portion is fixed to the second body, so that the elastic element is compressed and biases the follower surface of the follower against the friction surface of the friction portion.

2. The hinge assembly as claimed in claim 1, wherein the friction surface is formed at one end of the friction portion, the follower is a hollow cylindrical body, the follower surface is formed inside of the follower, a shape of the follower surface corresponds to that of the friction surface, and the follower surface and the friction surface are one of a spherical surface, a paraboloid, and a conical surface.

3. The hinge assembly as claimed in claim 1, wherein the first body comprises a first mounting plate, and a connecting portion extending from one end of the first mounting plate, the shaft support extends from one end of the connecting portion, the shaft portion comprises a pair of opposite projections extending perpendicularly from a first end thereof that adjoins the connecting portion, the friction portion comprises a plane formed at one end thereof and defines a transverse notch at the plane, and the projections are engaged in the notch.

4. The hinge assembly as claimed in claim 1, further comprising a clip, wherein the first body defines a peripheral clip groove, the clip is engaged in the clip groove and abuts against the second body.

5. The hinge assembly as claimed in claim 1, further comprising a washer, wherein the washer is located around the first body between the elastic element and the follower.

6. The hinge assembly as claimed in claim 1, wherein the second body defines a stepped cavity having a large diameter hole and a small diameter hole, and a resisting surface is formed between the small diameter hole and the large diameter hole.

7. The hinge assembly as claimed in claim 6, wherein the locking portion of the second body is formed in an inner wall of the second body that bounds the large diameter hole, and is an elongate groove that defines a rectangular cross-section.

8. The hinge assembly as claimed in claim 7, wherein the locking portion of the follower is formed in an outer wall of the follower, and is a block-shaped protrusion having a rectangular profile.

9. The hinge assembly as claimed in claim 6, further comprising a washer, wherein the washer is located around the first body, with one end of the elastic element abutting against the follower, and the other end of the elastic element abutting against one end surface of the washer, and the other end surface of the washer abutting against the resisting surface of the second body.

10. A foldable electronic device comprising a main body, a cover, and a hinge assembly, the main body and the cover connected by the hinge assembly such that the cover is pivotable relative to the main body, the hinge assembly comprising:
a first body comprising a shaft portion, a friction portion located around the shaft portion, and a first mounting plate, the friction portion being non-rotatable relative to the shaft portion and comprising a curved friction surface, the first mounting plate being configured for engaging with the cover of the foldable electronic device;
a follower comprising a curved follower surface and a locking portion, the follower being located around the shaft portion of the first body and being rotatable relative to the shaft portion;
a second body comprising a locking portion and a second mounting plate, the locking portion of the follower being engaged in the locking portion of the second body to prevent the follower from rotating relative to the second body, the second mounting plate being configured for engaging with the main body of the foldable electronic device; and
an elastic element located between the follower and the second body;
wherein a distal end of the shaft portion is fixed to the second body, so that the elastic element is compressed and biases the follower surface of the follower against the friction surface of the friction portion.

11. The foldable electronic device as claimed in claim 10, wherein the friction surface is formed at one end of the friction portion, the follower is a hollow cylindrical body, the follower surface is formed inside of the follower, a shape of the follower surface corresponds to that of the friction surface, and the follower surface and the friction surface are one of a spherical surface, a paraboloid, and a conical surface.

12. The foldable electronic device as claimed in claim 10, wherein the first body comprises a first mounting plate, and a connecting portion extending from one end of the first mounting plate, the shaft support extends from one end of the connecting portion, the shaft portion comprises a pair of opposite projections extending perpendicularly from a first end thereof that adjoins the connecting portion, the friction portion comprises a plane formed at one end thereof and defines a transverse notch at the plane, and the projections are engaged in the notch.

13. The foldable electronic device as claimed in claim 10, wherein the hinge assembly further comprises a clip, the first body defines a peripheral clip groove, the clip is engaged in the clip groove and abuts against the second body.

14. The foldable electronic device as claimed in claim 10, wherein the hinge assembly further comprises a washer, the washer is located around the first body between the elastic element and the follower.

15. The foldable electronic device as claimed in claim 10, wherein the second body defines a stepped cavity having a large diameter hole and a small diameter hole, and a resisting surface is formed between the small diameter hole and the large diameter hole.

16. The foldable electronic device as claimed in claim 15, wherein the locking portion of the second body is formed in an inner wall of the second body that bounds the large diameter hole, and is an elongate groove that defines a rectangular cross-section.

17. The foldable electronic device as claimed in claim 16, wherein the locking portion of the follower is formed in an outer wall of the follower, and is a block-shaped protrusion having a rectangular profile.

18. The foldable electronic device as claimed in claim 15, wherein the hinge assembly further comprises a washer, the washer is located around the first body, with one end of the elastic element abutting against the follower, and the other end of the elastic element abutting against one end surface of the washer, and the other end surface of the washer abutting against the resisting surface of the second body.
